(19) United States
(12) Patent Application Publication
(10) Pub. No.: US 2006/0156911 A1
(43) Pub. Date: Jul. 20, 2006

(54) Advanced magnetic circuit to improve both the solenoidal and magnetic functions of string instrument pickups with co-linear coil assemblies

(76) Inventor: Willi L. Stich, Corona, CA (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/036,905

(22) Filed: Jan. 15, 2005

(51) Int. Cl. G10H 3/18

(52) U.S. Cl. 84/726

(57) ABSTRACT

An electromagnetic pickup for a stringed musical instrument incorporating a magnetic structure placed between two elongated collinear coils of opposing polarity. The magnetic structure includes a number of ferromagnetic polepieces that extend through the collinear coils and two ferromagnetic moderator bars adjacent to and on opposite sides of the polepieces (within the area between the two coils) that are charged with one polarity by high coercive rare earth high coercive permanent magnets attached to the outer surface of the moderator bars.

### FIELD OF THE INVENTION

This invention relates to an electromagnetic pickup for converting vibrations of a musical instrument string into corresponding electrical signals, for example, a guitar pickup.

### BACKGROUND OF THE INVENTION

The traditional single coil magnetic pickup for stringed musical instruments as originally designed and offered by Fender Musical Instruments Corp. consists of a coil form with alnico magnets as its core that is wound with numerous turns of copper wire. This design set the standard for reproducing what is commonly known and recognized today as the Fender sound. Inherent to this original work are certain design choices that have been well documented and in some cases addressed to various degrees by other pickup designs. To some degree, many early pickup designs have been susceptibility to external electromagnetic radiation and the magnetic interference with the natural vibrations of the strings.

To address the electromagnetic interference, hum canceling coils, also known as humbucking coils, have been used in pickup designs. Hum canceling coils have been known since 1825 when Leopoldo Nobili invented the astatic galvanometer; where it is stated: “Two identical coils of N turns are connected in series, in such a way, that the current passes through them in opposite senses to neutralize external magnetic fields”. Collinear coil assemblies for electrical musical instruments have been known since the mid 1930s, with U.S. Pat. No. 2,119,584 most likely representing the first such patent. Many early pickup designs, due to the extremely small market demand at the time, were never patented.

Magnetic pickups of various designs have been used in the sound reproduction of stringed musical instruments since 1930. They are generally placed directly under the strings between the bridge and the end of the fingerboard of the instrument. In simplest terms,. the electromagnetic pickup in combination with the vibrating string represents a multi-frequency voltage generator. Magnetic pickups are an important component in what makes up the sound characteristics of a given amplified electric stringed musical instrument. Certain companies that manufacture these instruments have developed magnetic pickups that have contributed to what has become known over time as their signature sound. The acknowledgement of this sound signature has to be considered in the design of any new instrument and its component parts including the design of the pickup.

Based on changes that had taken place in musical instrument amplification (for example, digital sound recording equipment; computer interface for stringed musical instruments; changes in playing techniques and styles of music), Fender requested, in 1996, the development of a high performance electromagnetic pickup.

The pickup had to meet the following demands: (1) to not exceed the dimensions of Fender's traditional single coil pickups; (2) to generate a higher output voltage than their traditional single coil pickups; (3) to reproduce the legendary signature sound of their traditional single coil pickups; (4) to increase sensitivity to minute amplification adjustments allowing the player to select from a wider tonal variety; (5) to reduce the magnetic force directed towards the strings so as to minimize magnetic interference with the vibrating strings; (6) to neutralize the interference of external electromagnetic radiation; and (7) to be manufactured cost effectively.

These demands presented several major problems. To increase the output requires either stronger permanent magnets or more turns of wire. Stronger permanent magnets, due to their high coercive force, have negative solenoidal qualities. When placed close to the core of a solenoid they will cause magnetic saturation of the core resulting in a dramatic loss of their relative permeability and in addition will cause a strong magnetic interference with the vibrating string. More turns of wire would not only increase the impedance, resulting in a shift to undesired frequencies, but would also require a larger coil dimension. It was also important to consider that a vibrating string does not produce a pure tone that can be explained with the single curve of a sine wave. The tone of a vibrating string consists of several different sine waves, resulting in a complex waveform that can be found by adding the ordinates of all its component sine waves. This complex waveform represents the Fourier spectrum of a tone, which musicians simply call the “signature sound”. The Fourier spectrum depends partially on the position of a pickup in relation to the bridge of the instrument and the position, angle, and force of the attack. However, the most important factor is that the signal generated above the coil is in-phase with the signal generated at the sides of the coil.

A need exists to eliminate the negative functions of magnetic structures used in collinear coil assemblies.

### SUMMARY OF THE INVENTION

In this invention, the electromagnetic pickup comprises a magnetic structure which minimizes the magnetic effect on the natural vibration of the strings, and primarily provides an equal charge distribution of moderate magnetic intensity focused towards the strings and a secondary charge of much greater magnitude below the active coil parallel to the strings exceeding the width of the pickup. The magnetic structure includes a number of polepieces and two moderator bars. The materials of both bars and the polepieces are of high magnetic susceptibility to increase the self inductance in each of the coils, while reducing the negative mutual inductance inherent in collinear coils of reversed polarity. The moderator bars are charged with high coercive permanent magnets having about half the mass of the moderator bars, which are placed on the outer surface of the bars, i.e., the outer perimeter of the pickup. The combination of mass and placement of the high coercive permanent magnets eliminates any negative interferences. The magnetic structure is designed to enhance the performance of a pickup with two elongated collinear coils of opposing polarity to neutralize external electromagnetic radiation.

An additional objective in the design of this invention is that it could be manufactured cost effectively.

Other advantages, features and additional objects of the present invention will become manifest to those versed in the art upon making reference to the detailed description and the accompanying drawings in which a preferred structural embodiment incorporating the principles of the present invention is shown by way of illustrative example.

### BRIEF DESCRIPTION OF THE DRAWINGS

FIG. 1 illustrates an isometric view of an electromagnetic pickup embodying the present invention;

FIG. 2 illustrates magnetic lines of force through a cross-sectional end view of the pickup assembly;

FIG. 3 is a top view of the magnetic structure of the pickup;

FIG. 4 is a cross-sectional view of an end elevation of the magnetic structure of the pickup; and

FIG. 5 is an exploded isometric view of the pickup, the left end of such view corresponding to the bottom of the pickup assembly.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

The present invention is incorporated in an electric guitar, typically but not limited to a solid-body electric guitar. The word “guitar”, as employed in the present specification and claims, denotes any electric guitar, electric bass guitar, or any electric string musical instrument incorporating electromagnetic pickups.

The pickup shown in the drawings is for six-string guitars. However, the number of strings and the number of polepieces per pickup may vary with the design of the guitar.

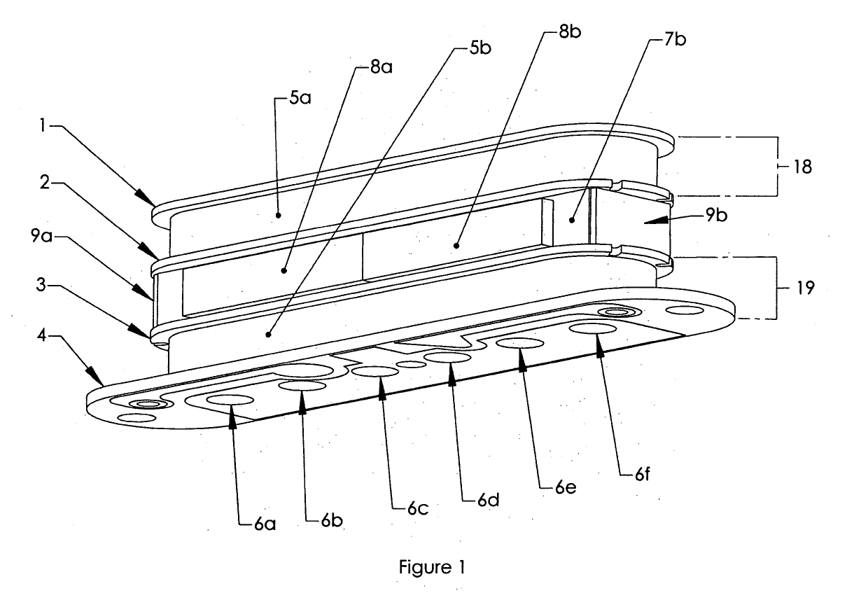

Referring to FIGS. 1-5, the core assembly of the pickup comprises an upper and lower bobbin each containing upper and lower flange plates separated by two hollow tubular spacers that incase the outer two polepieces; six ferromagnetic polepieces that extend through the entire assembly; two ferromagnetic moderator bars affixed to the polepieces; four high coercive permanent magnets that are affixed, two each to the outer surface of the moderator bars; and, two terminal plates that are attached across the ends of the moderator bars.

The bottom flange plate of the lower bobbin is extended on each end outside the perimeter of the core assembly with a hole in the extended area on each side used when affixing the pickup to the guitar. In addition, there is a printed circuit board or array on the bottom surface of the flange plate that is used to connect the pickup to the other electronic components of the guitar.

Each flange plate has a plurality of circular holes that correspond to the number of polepieces used for that particular pickup. These holes are to a dimension corresponding to the outside diameter of the polepieces so as to allow the assembly to be pressed together. An additional smaller diameter hole located in the center of each flange plate serves a dual purpose. It is used in mounting the core assembly to the coil winding machine and it allows for the release of air during the waxing process, allowing the wax to fully permeate the coil so as to avoid microphonic squealing.

The illustrated ferromagnetic pole pieces are of sufficient length to extend fully through the upper and lower bobbin sections.

To further describe the pickup shown in drawing FIGS. 1-5, it comprises an upper bobbin 18, a lower bobbin 19, six ferromagnetic pole pieces 6a, 6b, 6c, 6d, 6e, and 6f, two ferromagnetic moderator bars 7a and 7b, four high coercive permanent magnets 8a, 8b, 8c, and 8d, upper and lower coils or windings of wire 5a and 5b, and two terminal plates 9a and 9b.

Flange plates 1, 2, 3 and 4 are made from an electrically insulating material, preferably fiberglass. Upper bobbin 18 has top flange plate 1 and bottom flange plate 2 mounted parallel to each other, spaced to a predetermined width by two tubular spacers 10a and 10b, to assemble a bobbin onto which coil 5a is wound. Lower bobbin 19 has top flange plate 3 and bottom flange plate 4 mounted parallel to each other, spaced to a predetermined width by two tubular spacers 10c and 10d, to assemble a bobbin onto which coil 5b is wound, in reverse polarity of upper coil 5a. The coils 5a and 5b are parallel to each other. Flange plates 2 and 3 have slots to protect wire that is extended down to flange plate 4. Flange plate 4 is extended on each end outside the perimeter of the core assembly with a hole in the extended area on each side for mounting purposes. In addition, there is a printed circuit array on the bottom surface of flange plate 4 that is used in connecting to the other electronic components of the guitar.

The six ferromagnetic pole pieces 6a, 6b, 6c, 6d, 6e, and 6f are mounted parallel to each other through the holes in the flange plates 1 and 2 of upper bobbin 18, and flange plates 3 and 4 of lower bobbin 19, as shown, using friction to hold the bobbin assembly together. In addition, ferromagnetic pole piece 6apasses through spacers lob and 10c, while ferromagnetic pole piece 6f passes through spacers 10a and 10d.

The ferromagnetic moderator bars 7a and 7b are mounted between and perpendicular to flange plates 3 and 4; adjacent to the six ferromagnetic polepieces 6a, 6b, 6c, 6d, 6e, and 6f.

The four high coercive permanent magnets 8a, 8b, 8cand 8d are mounted between and perpendicular to the flange plates 3 and 4; affixed directly to the outer surface of the ferromagnetic moderator bars 7a and 7b. High coercive permanent magnets 8a and 8b are affixed to the ferromagnetic moderator bar 7a, and high coercive permanent magnets 8c and 8d are affixed to the ferromagnetic moderator bar 7b.

The magnetic north pole of the four high coercive permanent magnets 8a, 8b, 8c, and 8d is on the side facing the outer surface of moderator bars 7a and 7b.

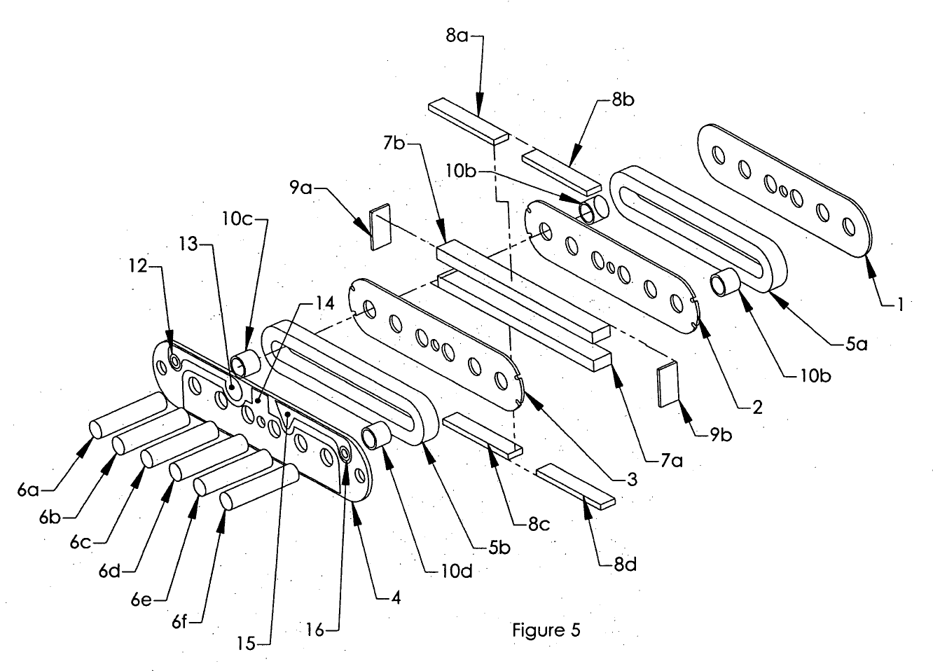

Electrical connection points 12 and 16 on the bottom surface of flange plate 4, and electrical connection points on the two terminal plates 9a and 9b, allow that the coils can be connected in either series or parallel modes in opposite polarities, see FIG. 5. In both the series and parallel configurations, connection points 13 and 15 represent the resulting connections of both coils to allow reversed polarity wirings in multi-pickup combinations. Connection point 14 represents the common ground for the magnetic poles via the PC board (flange plate 4).

FIG. 4 is a cross-sectional view of an end elevation of the magnetic structure of the pickup. It shows high coercive permanent magnets 8a and 8c affixed to the outer surface of ferromagnetic moderator bars 7a and 7b, which are in turn affixed to the outer surface of ferromagnetic polepiece 6a. Dotted line 17 down the center of high coercive permanent magnets 8a and 8c represents the center of the magnetic dipole function where the outer side shows the south pole (S) and the inner side affixed to the outer surface of the ferromagnetic moderator bars 7a and 7b represents the north pole (N) charging the ferromagnetic moderator bars 7a and 7b and the polepieces 6a, 6b, 6c, 6d, 6eand 6f to one single magnetic polarity.

FIG. 3 is a top view of the magnetic structure of the pickup. It shows high coercive permanent magnets 8a and 8b affixed to the outer surface of ferromagnetic moderator bar 7a; high coercive permanent magnets 8c and 8d affixed to the outer surface of ferromagnetic moderator bar 7b; with the ferromagnetic moderator bars 7a and 7b affixed to the outer surface of ferromagnetic polepieces 6a, 6b, 6c, 6d, 6e, and 6f; and, terminal plates 9a and 9b affixed to the opposite ends of ferromagnetic moderator bars 7a and 7b. The reason that the high coercive permanent magnets 8a and 8b, and, 8cand 8d are cut in segments, and not used as a single longer bar, is not related to the function of the invention but due to the fact that high coercive magnetic material is extremely brittle by nature and, when formed to a thickness as thin as used in the invention, it is prone to breakage.

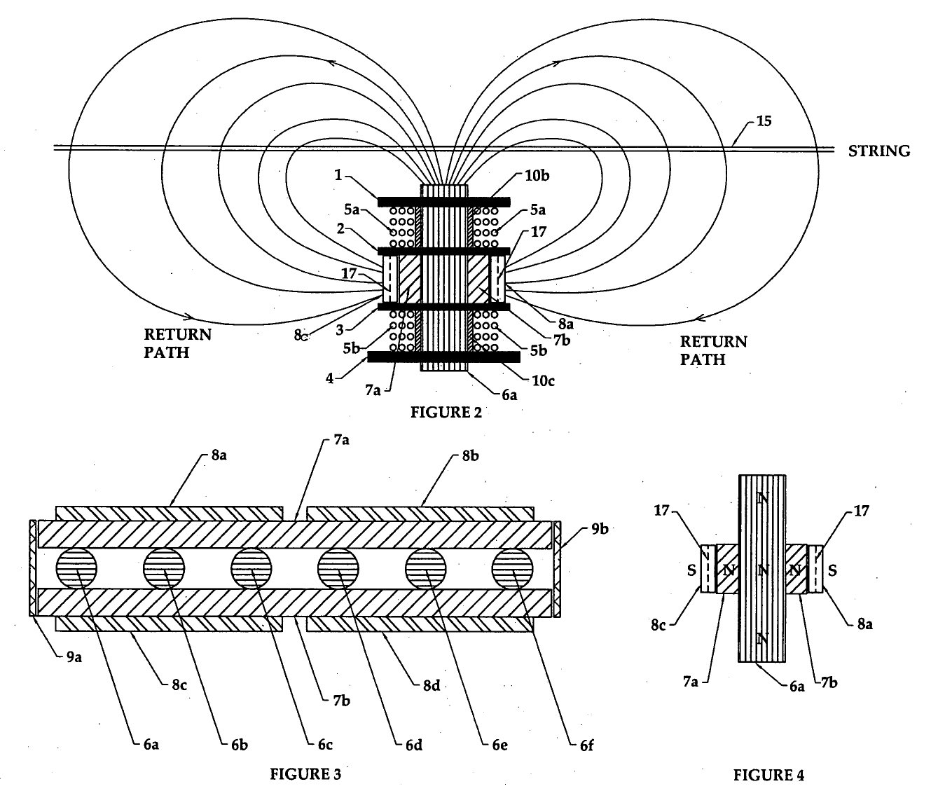

FIG. 2 illustrates magnetic lines of force through a cross-sectional end view of the pickup assembly. It shows flange plate 1 and 2 separated by tubular spacer lob encasing ferromagnetic polepiece 6a, and coil 5a; high coercive magnet 8c affixed to the outer surface of ferromagnetic moderator bar 7a; high coercive magnet 8a affixed to the outer surface of ferromagnetic moderator bar 7b; ferromagnetic bars 7a and 7b affixed to the outer surface of ferromagnetic polepiece 6a; flange plate 3 and 4 separated by tubular spacer 10c encasing ferromagnetic polepiece 6a, and coil 5b; a ferromagnetic guitar string 15; dotted line 17 down the center of high coercive permanent magnets 8a and 8c; and the magnetic lines of force.

High coercive permanent magnets have negative solenoidal qualities. When placed close to the core of a solenoid they cause a high saturation of the core resulting in a dramatic loss of the cores relative permeability and causing an increase of the effective resistance of the coil. The other factor is that the increase of magnetic force of the polepieces towards the strings will hinder the strings from vibrating evenly, resulting in false overtones and loss of sustain.

In this invention the ferromagnetic moderator bars serve two different functions: (A) magnetic and (B) solenoidal. In function A, the moderator bars equally distribute a reduced magnetic charge, induced by the high coercive source magnets, to the ferromagnetic pole pieces, thus minimizing the magnetic effect on the natural vibration of the strings, and since the ferromagnetic bars have a greater mass and greater dimension than the high coercive permanent source magnets, to avoid magnetic fringing. In function B, the moderator bars increase the self inductance of the individual coils, and reduce the leakage inductance between the coils, to predetermined magnitudes to cancel eddy currents.

In this invention the high coercive permanent magnets 8a, 8b, 8c and 8d have about half the mass of the ferromagnetic moderator bars 7a and 7b, and are placed adjacent to the ferromagnetic moderator bars 7a and 7b close to the perimeter of the pickup, without making direct contact with ferromagnetic polepieces 6a, 6b, 6c, 6d, 6eand 6f, and are not under, next to or inside the core assembly thus meeting the criteria as described above.

While placing the high coercive permanent magnets 8a, 8b, 8c, and 8d on the outside surface of the ferromagnetic moderator bars 7a and 7b reduces the magnetic force transmitted to the polepieces 6a, 6b, 6c, 6d, 6e, and 6f to a determined quantity, the ferromagnetic moderator bars 7a and 7b function as magnetic keepers increasing the magnetic force on the outside surface of the high coercive permanent magnets 8a, 8b, 8c, and 8d creating a strong magnet field that is parallel to the string 15. The parallel field, while it does not interrupt the natural vibration of the string 15, does extend the width of the magnetic field beyond the physical dimension of the pickup itself.

While one or more embodiments of the present invention have been illustrated in detail, the skilled artisan will appreciate that modifications and adaptations to those embodiments may be made without departing from the scope of the present invention as set forth in the following claims.

What is claimed is:

1. A magnetic pickup for stringed musical instruments having ferromagnetic strings, the pickup comprising:
a pair of axially spaced coils to have their axis extended perpendicular to the length of the strings:
a plurality of ferromagnetic poles extending through the first and second coils;
first and second coils are separated by first and second ferromagnetic moderator bars adjacent to each side of the ferromagnetic poles; and
high coercive permanent magnets are affixed to the sides of the first and second ferromagnetic bars opposite the plurality of ferromagnetic poles.

2. The pickup according to claim 1 in which two coils are connected, either in series or parallel mode, in an out of phase relationship to each other.

3. The pickup assembly according to claim 1 in which the coils are respectively disposed on a pair of bobbins, the bobbins and ferromagnetic bars being held together by the plurality of ferromagnetic poles that are press fit into the bobbins.

4. The pickup according to claim 1 in which the coils, and the poles are elongated in a direction transverse to the string length as to be responsive to a plurality of parallel strings.

5. The pickup according to claim 1 wherein the separation between the coils is of a greater dimension than the height of each of the coils and the total height of the pickup does not exceed 0.900 inches.

6. The magnetic pickup according to claim 1 wherein the high coercive permanent magnets have approximately half the mass of the ferromagnetic bars.

7. The magnetic pickup according to claim 1 wherein the high coercive permanent magnets are magnetically oriented parallel to the direction of the strings disposed with one magnetic polarity to the ferromagnetic bars which induce the same magnetic polarity into the plurality of ferromagnetic poles and the other magnetic polarity is directed parallel to the strings away from the pickup.

8. The magnetic pickup according to claim 1 in which two the coils are not directly influenced by the dipole function of the high coercive permanent magnets.
